(19) United States
(12) Patent Application Publication
(10) Pub. No.: US 2002/0147620 A1
(43) Pub. Date: Oct. 10, 2002

(54) Software quality assurance management system

(76) Inventor: Thomas J. Walsh, Pickerington, OH (US)

Correspondence Address: Richard J. Minnich, Esq., Fay, Sharpe, Fagan, Minnich & McKee, Seventh Floor, 1100 Superior Avenue, Cleveland, OH, 44114, US

(21) Appl. No.: 09/773,297

(22) Filed: Jan. 31, 2001

(51) Int. Cl. G06F 17/60

(52) U.S. Cl. 705/7

(57) ABSTRACT

A method for auditing an activity, which is implemented at an organization, documents an activity to be audited within a database. The database is included in a network accessible by the organization and an auditing entity. The activity is audited. A determination is made if the audited activity produces a finding. If the audited activity produces the finding, the finding is documented within the database. A notification of the finding is automatically transmitted, via the network, from the auditing entity to the organization.

### BACKGROUND OF THE INVENTION

The present invention relates to the field of software quality assurance. It finds particular application in conjunction with a networked automated Software Quality Assurance (“SQA”) management system for managing an entire SQA program and will be described with particular reference thereto. Although this invention was created for an SQA program, it is to be appreciated that the invention is applicable to all quality assurance and auditing programs, including, for example, ISO 9000 and TL 9000 audits, manufacturing audits, and other like applications.

The Software Engineering Institute's (“SEI”) Software Capability Maturity Model (“CMM”) establishes SQA as a Key Process Area (“KPA”). To obtain a CMM Level 2 (or better) rating the SQA KPA must be fully satisfied. The CMM has become the leading software improvement model in the industry and as such many of the software companies are ensuring their development processes meet the intent of the CMM. Furthermore, the United States government requires that any company awarded a government software development contract must be assessed at CMM Level 3 or better. Whether through government regulation or voluntary choice of individual companies, SQA has become a very vital practice in the software industry.

While great pressures exist for businesses to be assessed at higher CMM levels, the requirements of the SQA KPA may be quite burdensome for companies to implement. Traditionally, SQA programs have been implemented by completing finding and observation forms either manually or with a word processor. Reports are generated either manually or via word processors/spreadsheets. Additionally, hard-copies of the forms and reports are typically stored on-site (e.g., in filing cabinets). Lastly, responses to the findings are handled by manually completing the corrective and/or preventative actions before mailing them back to an SQA Engineer (e.g., auditor) for approval. The conventional methods for completing finding/observation forms, generating reports, and resolving the finding/observation are slow and tedious, especially because interactions may go through several iterations until the parties agree on the proper course of action to resolve the finding/observation.

The present invention provides a new and improved method and apparatus which overcomes the above-referenced problems and others.

### SUMMARY OF THE INVENTION

A method for auditing an activity, which is implemented at an organization, documents an activity to be audited within a database. The database is included in a network accessible by the organization and an auditing entity. The activity is audited. A determination is made if the audited activity produces a finding. If the audited activity produces the finding, the finding is documented within the database. A notification of the finding is automatically transmitted, via the network, from the auditing entity to the organization.

In accordance with one aspect of the invention, a determination is made if the audited activity produces an observation. If the audited activity produces the observation, the observation is documented within the database. A notification of the observation is automatically transmitted, via the network, from the auditing entity to the organization.

In accordance with another aspect of the invention, the finding is resolved.

In accordance with a more limited aspect of the invention, the resolving step includes developing, within the organization, a proposed response for resolving the finding and transmitting, via the network, the proposed response to the auditing entity.

In accordance with a more limited aspect of the invention, the resolving step includes determining if the proposed response is acceptable to the auditing entity. If the proposed response is acceptable, the proposed response is implemented at the organization. If the proposed response is not acceptable, a first negotiation between the organization and the auditing entity is performed to determine a negotiated response. If the negotiated response is acceptable to both the organization and the auditing entity, the negotiated response is implemented at the organization. If the negotiated response is not acceptable to both the organization and the auditing entity, the status of the finding is escalated.

In accordance with an even more limited aspect of the invention, a determination is made if the implemented response is acceptable to the auditing entity. If the implemented response is acceptable to the auditing entity, a status of the finding is set to resolved. If the implemented response is not acceptable to the auditing entity, second negotiations are performed between the organization and the auditing entity. If the second negotiations do not result in a response acceptable to both the organization and the auditing entity, a status of the finding is escalated.

In accordance with another aspect of the invention, a report summarizing the finding is transmitted, via the network, to a predefined addressee.

One advantage of the present invention is that it provides a distributed computer-based automated Software Quality Assurance (SQA) Management System, which may be used to implement and manage an SQA program.

Another advantage of the present invention is that it provides a computer-based automated SQA management system in which planned (and completed) activities are recorded, findings and observations are managed, and reports are automatically generated.

Another advantage of the present invention is that it provides a means for planning and documenting SQA activities, recording and tracking findings and observations, and providing SQA program analysis and reports.

Another advantage of the present invention is that it provides a means for communicating between an SQA Engineer and an organization while maintaining a historical record of the communications.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 illustrates a network environment in which the SQA Management System is implemented according to the present invention;

FIG. 2 illustrates a block of the SQA Management System shown in FIG. 1;

FIG. 3 illustrates a flowchart of a high-level process implemented by the SQA Management System shown in FIG. 1;

FIG. 4 illustrates a flowchart of a finding notification and response process implemented by the SQA Management System shown in FIG. 1;

FIG. 5 illustrates a flowchart of a finding resolution, verification, and closure process implemented by the SQA Management System shown in FIG. 1; and

FIG. 6 illustrates a flowchart of a periodic reporting process implemented by the SQA Management System shown in FIG. 1.

### DETAILED DESCRIPTION OF THE PREFERRED EMBODIMENTS

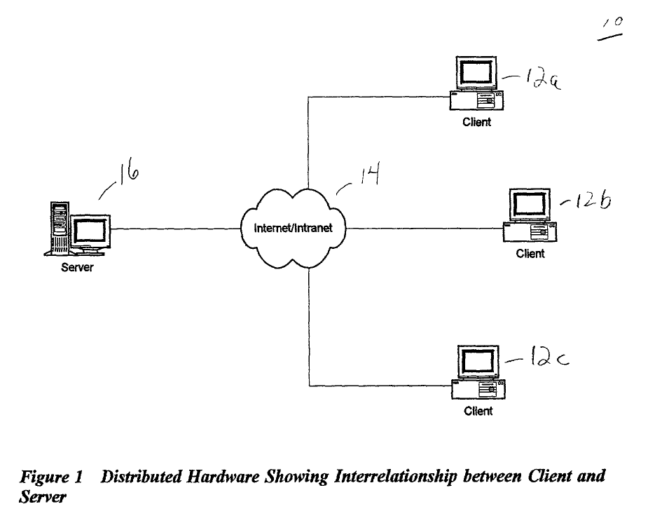

FIG. 1 illustrates a network environment 10 in which various features of the present invention are implemented. In particular, the network environment 10 includes client computer systems 12a, 12b, 12c, a network 14 (e.g., an Internet/Intranet), and a server computer system 16, which includes a mass storage device such as a hard disk (or RAID device). Although three (3) client computers 12a, 12b, 12c are disclosed in the preferred embodiment, it is to be understood that any number of client computer systems are contemplated.

The client computer systems 12 are operable by users at respective organizations, which implement an organizational activity to be audited, for communicating with the server computer system 16 via the network 14. In this manner, users at the audited organizations access services provided by the server computer system 16 via the client computer systems 12. To this end, each of the client computer systems 12 includes conventional computer hardware (e.g., a processor, memory, mouse, keyboard, network interface card) that in combination execute client software (e.g., e-mail clients, web browsers, file mangers) that provide an interface to services provided by the network 14.

Although the preferred embodiment is described in terms of auditing an organizational process, it is to be understood that the organizational activities that may be audited include any organizational process, work product, record (e.g., quality record), metric (e.g., measurement), modification request, and/or inspection. Furthermore, any other organizational activity that may be audited is also contemplated.

The network 14 is operable to provide a communications link between the client computer systems 12 and the server computer system 16. It is contemplated that the network 14 be implemented with various media (e.g., wireless, coaxial cable, twisted pairs, fiber optical cables, switches, and/or routers) and networking protocols (e.g., Ethernet, NETBUI, TCP/IP, and/or ATM). In a preferred embodiment, the network 14 includes multiple geographically disbursed local area networks (LANs) that are interconnected to form a wide area network (WAN). More specifically, in a preferred embodiment, the network 14 utilizes gateway computer systems and the Internet to interconnect the geographically disperse LANs.

The server computer system 16 is operable to communicate with the client computer systems 12 via the network 14 and provide the client computer systems 12 with various services. To this end, the network 14 preferably includes conventional computer hardware (e.g. a processor, memory, input device) which in combination execute software that implements services 18 provided by the server computer system. Examples of services that the server computer system 16 may provide are print services, application services, file services, database services, e-mail services, proxy services, web services, name resolution services (e.g. DNS, WINS), ftp services, news services, gateway services, and/or telenet services. In particular, the server computer system 16, in accordance with the present invention, is operable to provide the client computer systems 12 with a software quality assurance management service.

Although the preferred embodiment shows the services (e.g., the database services) 18 included in the network 14, it is to be understood that one or more of the services may also be implemented from the server computer system 16.

Software Quality Assurance Management System Architecture

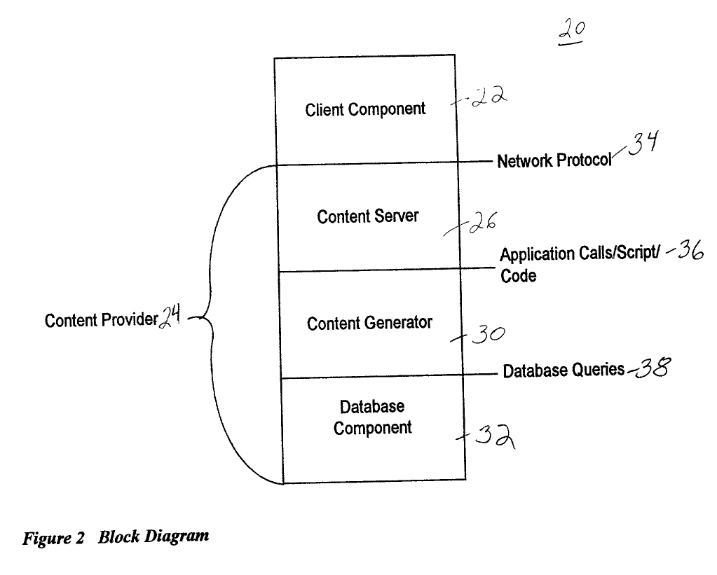

With reference to FIGS. 1 and 2, a Software Quality Assurance (“SQA”) Management System 20 may be implemented upon the network environment 10. In general, the SQA Management System 20 provides a mechanism for the implementation and management of an SQA program for auditing a process at an organization. The system 20 is used to plan and document SQA activities, record and track findings and observations, and provide SQA program analysis and reports. The SQA Management System 20 also provides a mechanism of communication between an SQA Engineer (an auditor or auditing entity) and users at an audited organization, which access the client computer system 12, and maintains historical records of these communications.

The SQA auditing activities may include reviewing aspects of various work products for a process (e.g., quality records, design documents, and requirements documents). The SQA Engineer documents the planned auditing activities within the system 20 by entering the planned activities into the database 18 preferably using a predesigned form.

As will be discussed in more detail below, once the SQA activities are planned and documented in the database 18, the planned activities are implemented at the appropriate time. For example, the auditor may review design documents, at the scheduled time, to identify observations and/or findings. An observation represents a non-mandatory recommendation regarding the audited activity. For example, the SQA Engineer may recommend a more efficient manner for implementing one aspect of the design being audited. A finding, on the other hand, represents a deficiency in the audited activity that requires action to be taken by the audited organization. For example, the SQA Engineer may discover that the design proposed in the document being audited will not work (i.e., is deficient). The auditor communicates the observation(s) and/or finding(s) to the user (i.e., the client computer system 12) at the audited organization via the system 20. In this manner, communication is set up between the SQA Engineer and the user so that findings may be resolved.

The SQA Management System 20 includes a client component 22 and a content provider component 24. In general, the client component 22 corresponds to software executing on the client computer systems 12, and the content provider component 24 corresponds to software executing on the server computer system 16. The client component 22 in conjunction with the client computer system 12 provides a user interface to the SQA Management System 20 from which a user may transfer requests to the content provider component 24 of the SQA Management System 20. Moreover, the client component 22 is operable to display content received from the content provider component 24 in response to user requests.

In the preferred embodiment, the client component 22 is implemented with a conventional web browser. Accordingly, from the client software perspective, the SQA Management System 20 of the preferred embodiment is platform independent. However, it should be appreciated that the client component 22 of the SQA Management System 20 may be implemented with software other than conventional web browser software. In particular, the client component 22 could be implemented as an application program that uses different protocols to communicate with the content provider component 24.

The content provider component 24 is generally operable to receive user requests from the client components 22, dynamically generate content in response to the user requests, and provide the generated content to the client components 22. To this end, the content provider component 24 in the preferred embodiment includes a content server component 26, a content generator component 30, and a database component 32.

In the preferred embodiment, the database component 32 is implemented with two database servers. One database server is used to store documents (e.g., user guide, report templates, reports, etc.) and the other database server is used to store data from which the content generator component 30 generates dynamic content. It should be appreciated that while the preferred embodiment of the SQA Management System 20 utilizes two (2) database servers to implement the database component 32, the database component 32 may be implemented by one (1) or more databases. Moreover, document storage could be implemented using a file server.

The content server component 26 is operable to receive user requests from the client component 22 and provide dynamically generated content to the client components 22.

The content generator component 30, in general, is operable to dynamically generate content for the content server component 26 in response to the content server component 26 launching scripts, code and/or software calls. More specifically, the content generator component 30 is operable to query the database component 32 to obtain information from the database component 32, dynamically format the obtained information, and provide the content server component 26 with dynamically formatted information so that the content server 26 may deliver the information (i.e. content) to the requesting client component 22.

The client component 22 communicates with the content provider 24 via a network protocol 34 (e.g., Ethernet, NETBUI, TCP/IP, and/or ATM). Within the content provider 24, the content server 26 communicates with the content generator 30 via various application calls/script/code 36. The application calls/script/code 36 is typically built into the client application and may, for example, properly size a form for display on one of the client computer systems 12, which are a part of the client component 22. The content generator 30 communicates with the database component 32 via various database queries 38.

Software Quality Assurance Management System

The architecture described above provides a general framework in which an SQA Management System 20 may be implemented. In particular, the preferred embodiment of the present invention configures the SQA Management System 20 to implement an SQA program that complies with the requirements of the CMM defined by the Software Engineering Institute (“SEI”) at Carnegie-Melon University. However, in other embodiments, the SQA Management System 20 may also be configured to implement other types of quality assurance and/or auditing programs such as those used for ISO 9000 and/or TL 9000.

In the preferred embodiment of the present invention, the SQA Management System 20 is used to implement a system that provides all of the functions necessary to implement a CMM conforming SQA program. In particular, the SQA Management System 20 is programmed to provide security features, activity and finding management, document storage and retrieval, metrics, reports, forms, etc.

To this end, the SQA Management System 20 is programmed to provide the following (in a systematic manner) to an auditor and/or an employee at the audited organization:

1. templates (i.e. forms) used to document the planning/completion of tasks under the SQA program;

2. templates used to document the management of findings and/or observations;

3. metrics and reports used to manage the SQA program;

4. a communication mechanism between the auditor and the audited organization; and

5. an on-line users guide to effectively configure, use and administer the SQA Management System

Operation of a Preferred Embodiment of the SQA Management System

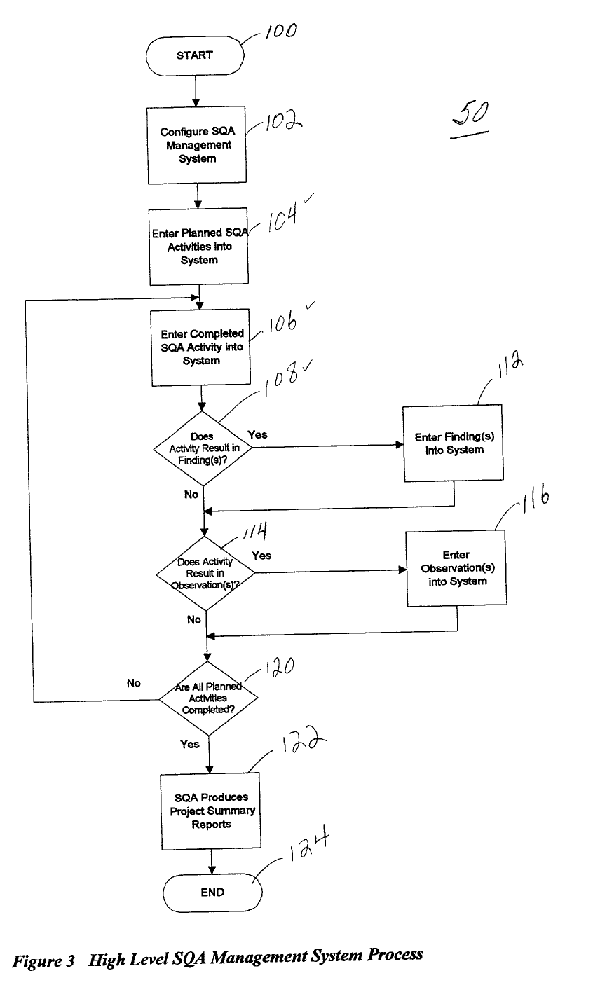

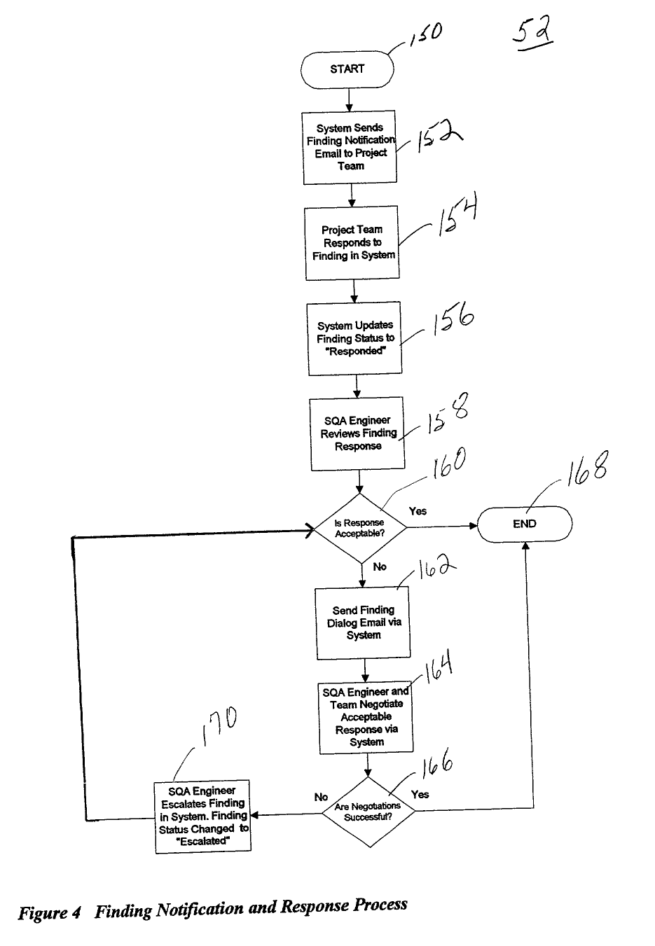

FIGS. 3-6 illustrate operational flowcharts 50, 52, 54, 56 of the preferred embodiment of the SQA Management System 20. In a preferred embodiment, each of the data entry steps illustrated in FIGS. 3-6 is accomplished via a form specifically designed for the particular step/task. The form is completed by the various users via the client computers 12.

With reference to FIGS. 2 and 3, a high-level SQA Management System process 50 begins in a step 100. A system administrator configures, in step 102, the SQA Management System 20 to support the requirements of an organization being audited. Configuring the system 20 includes, for example, inputting information needed to establish plans for specific releases of the organization's product(s). In the preferred embodiment, the system 20 is configured via an SQA planning/configuration form displayed on one of the client computer systems 12, which is accessed by the SQA Engineer. The SQA planning/configuration form captures information regarding user logins/passwords, organizational and project information, finding response, resolution and escalation intervals, and recipients (and e-mail addresses) for each of the reports. More specifically, the form collects information about the organization being audited and how that organization intends to implement SQA. Examples of the information collected in the SQA planning/configuration form include the name of the organization, the name of the project, the name(s) of the customer(s), delivery dates associated with the project, the maximum number of days allowed for a response to major and minor findings (e.g., 14 and 21, respectively), a path name to the database, the maximum number of days allowed for a resolution to major and minor findings (e.g., 60 and 120, respectively), the maximum number of days allowed for verifying the resolution to a major or minor finding is acceptable (e.g., 210 for both major and minor findings), the maximum number of days allowed before escalating a finding if a major or minor finding is not resolved (e.g., 14 for both major and minor findings), and the names and contact information (including e-mail addresses) of persons who will be contacted (e-mailed) if a finding is escalated.

Once the SQA Management System 20 has been configured, the SQA Engineer documents, in a step 104, each of the planned auditing activities in the system 20. The auditing activities are documented, using the SQA planning/configuration form, by entering tracking information (e.g., identifying the names and scheduling dates for the activities to be tracked) associated with the activities. As discussed above, the audited activities may include reviewing quality records, design documents, and/or requirements documents, etc. The audited activities are performed at the scheduled times (as defined by the tracking information entered in the step 104).

Once a particular SQA activity has been accomplished, the SQA Engineer (auditor) records (via an activity form displayed on the client computer 12), in a step 106, the completed activity in the system 20. Information regarding the activity name, the date the activity was performed, and/or notes about the activity are captured in the activity form. A determination is made, in a step 108, whether the particular activity produces finding(s) (i.e., shows the process is deficient). If it is determined in the step 108 that findings are produced, control passes to a step 112 in which the SQA engineer enters (documents) the finding(s) in the system 120 via a finding form displayed on the client computer 12. The step 112 is described in more detail below. Information such as the activity during which the finding was discovered, the finding type, and a detailed description of the finding is entered in the finding form. In the preferred embodiment, there are two types of finding: a Process Nonconformance finding, and a Quality Jeopardy finding. The Process Nonconformance finding indicates the organization failed to follow the guidelines of the process; the Quality Jeopardy finding indicates that the organization followed the prescribed process, but that the process itself may be flawed and, therefore, produce defective results. Control then passes to a step 114 for determining if the particular activity results in observations. Otherwise, if it is determined in the step 108 that no findings are produced, control passes directly to the step 114.

If it is determined in the step 114 that the particular activity produces observation(s), the SQA engineer enters (records) (via an observation form displayed on the client computer 12), in a step 116, the observations(s) in the system in the system 20. Information regarding the activity name and date, the project, and a description of the observation are captured in the observation form. Control then passes to a step 120 for determining if all the planned activities are completed. Otherwise, if it is determined in the step 114 that the particular activity produces no observation(s), control passes directly to the step 120.

If it is determined in the step 120 that all the planned activities are not completed, control returns to the step 106 for processing the next planned activity; otherwise, control passes to a step 122 for producing project summary reports. The high-level SQA Management System process 50 ends in a step 124.

With reference to FIGS. 1, 2 and 4, a finding notification and response process 52, which corresponds to the step 112, begins in a step 150. The system 20 sends notification, in a step 152, of any findings to the audited organization via the client computer systems 12. More specifically, the system 20 automatically transmits the notification from the auditing entity to the organization through the network 14 via an e-mail. In a step 154, the audited organization determines a proposed response to the finding and transmits the proposed response to the auditor via the system 20. The system 20 automatically updates the finding status, in a step 156, to indicate that the response has been sent. The SQA Engineer reviews the finding response, in a step 158, and determines, in a step 160, if the finding response is acceptable.

If it is determined in the step 160 that the finding response is not acceptable to the auditor, he/she sends, in a step 162, a finding discussion e-mail via the system 20. The auditor and the audited organization negotiate, in a step 164, an acceptable finding response via e-mail with all communication between the parties captured in the system for historical purposes. A determination is made, in a step 166, whether the negotiations are successful. If the negotiations are successful, control passes to a step 168 for ending the finding notification and response process 52; furthermore, the negotiated response is implemented by the organization. Otherwise, control passes to a step 170 in which the finding status is escalated in the system 20 by the auditor. Control then returns to the step 160.

The timing and individuals involved at each of the escalation levels are set in the configuring step 102. Preferably, there are three (3) levels of escalation. The system 20 automatically escalates the status of a finding from the lowest level to the highest level as a function of the due dates that have passed without the finding being resolved. Alternatively, the auditor and/or the project team may manually escalate the finding by completing a Finding Escalation Form via the client computer 12. When manually escalating the finding, the level and type (discussed below) are specified by the party escalating the finding.

Furthermore, there are three (3) types of escalation: 1) “Not Accepted by Team” indicates that the project team at the audited organization disagrees with the SQA Engineer on the validity of the finding, the extent of the response, or the completeness or effectiveness of the correction action to resolve the finding; 2) “Requires Management Assistance” indicates that, although there is agreement, the resources are not available to continue with corrective action; and 3) “Overdue Finding/Response Resolution” indicates if a response and/or resolution is not achieved by the specified date. As discussed above, the system 20 automatically escalates the status of a finding to the “Overdue Finding/Response Resolution” if a due date has passed.

If it is determined in the step 160 that the finding response is acceptable to the auditor, control passes directly to the step 168 for ending the finding notification and response process 52.

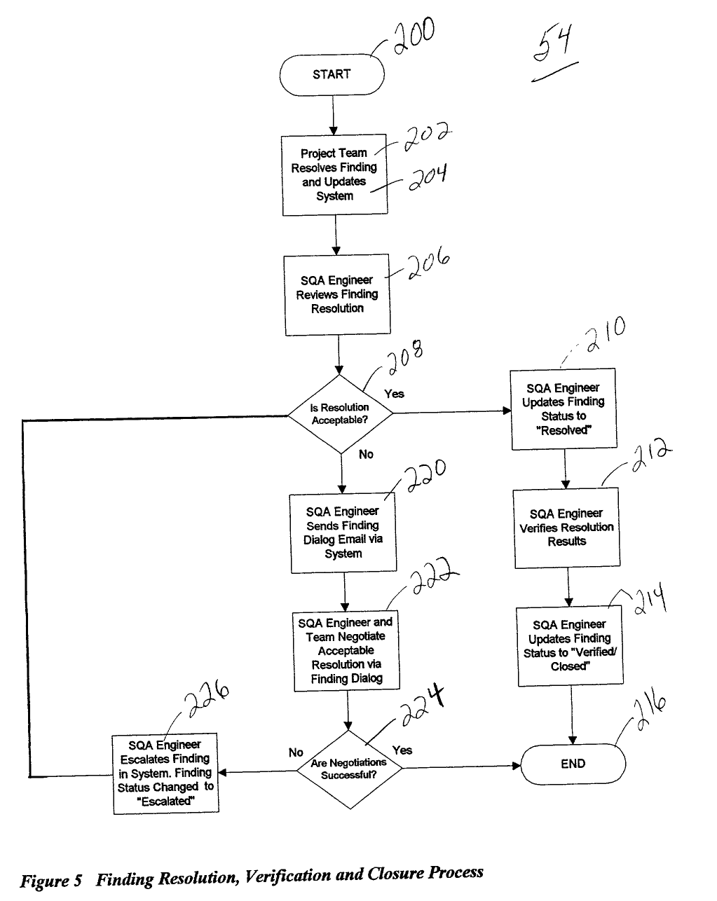

With reference to FIGS. 2 and 5, a finding resolution, verification, and closure process 54 begins in a step 200. A project team takes corrective and/or preventive action to resolve the finding in a step 202. The finding resolution is entered in the system 20 and transmitted to the SQA Engineer in a step 204. The SQA Engineer reviews the finding resolution in a step 206. A determination is made, in a step 208, whether the resolution is acceptable.

If the finding resolution is determined in the step 208 to be acceptable to the auditor (the SQA Engineer), the auditor updates the finding status to “Resolved” in a step 210. Then, the auditor verifies the finding resolution results in a step 212. The auditor closes the finding by updating the finding status to “Verified/Closed” in a step 214. The finding resolution, verification, and closure process 54 ends in a step 216.

If the finding resolution is determined in the step 208 to not be acceptable to the auditor (the SQA Engineer), the SQA Engineer sends, in a step 220, a finding discussion e-mail via the system 20 to the respective user (i.e., client computer 12). The auditor and the audited organization negotiate, in a step 222, an acceptable finding resolution via e-mail with all communication between the parties being captured in the system for historical purposes. A determination is made, in a step 224, whether the negotiations are successful.

If it is determined in the step 224 that the negotiations are successful, control passes to the step 216 for ending the finding resolution, verification, and closure process 54. If, on the other hand, it is determined in the step 224 that the negotiations are not successful, control passes to a step 226 in which the SQA Engineer changes the status of the finding in the system 20 to “Escalated.” In this manner, the auditor escalates the finding in the system 20. Control then returns to the step 208.

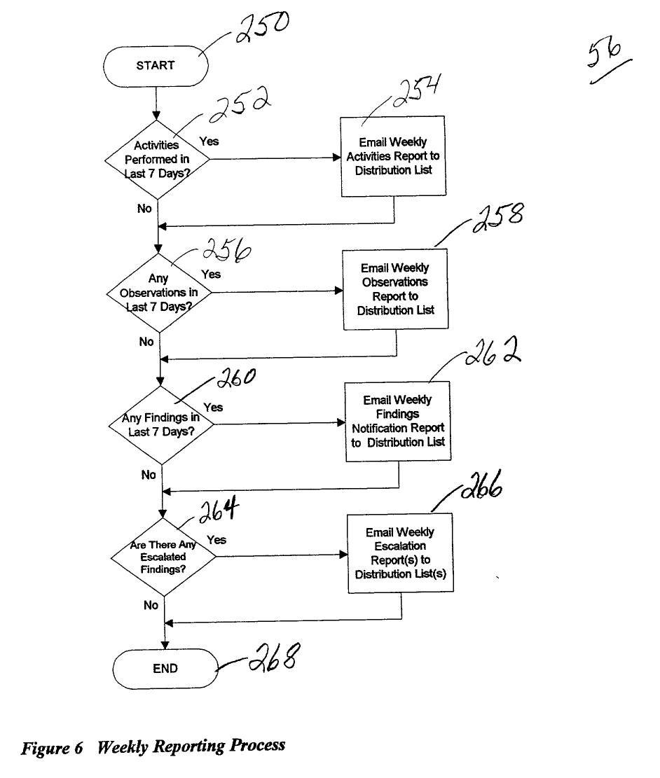

With reference to FIGS. 2 and 6, a periodic (e.g., weekly) reporting process 56 begins in a step 250. A determination is made, in a step 252, whether any activities were performed during, for example, the last seven (7) days. If it is determined in the step 252 that activities have been performed in the last seven (7) days, control passes to a step 254 for automatically transmitting (e.g., e-mailing) a weekly Activities Report to a specified distribution list; control then passes to a step 256. If, on the other hand, it is determined in the step 252 that no activities have been performed in the last seven (7) days, control passes directly to the step 256.

In the step 256, a determination is made if any observations were made during, for example, the last seven (7) days. If it is determined in the step 256 that observations were made in the last seven (7) days, control passes to a step 258 for automatically transmitting (e.g., e-mailing) a weekly Observations Report to a specified distribution list; control then passes to a step 260. If, on the other hand, it is determined in the step 256 that no observations were made in the last seven (7) days, control passes directly to the step 260.

In the step 260, a determination is made if any findings were made during, for example, the last seven (7) days. If it is determined in the step 260 that findings were made in the last seven (7) days, control passes to a step 262 for automatically transmitting (e.g., e-mailing) a weekly Findings Report to a specified distribution list; control then passes to a step 264. If, on the other hand, it is determined in the step 260 that no findings were made during the last seven (7) days, control passes directly to the step 264.

In the step 264, a determination is made if any escalated findings exist. If it is determined in the step 264 that escalated findings exist, control passes to a step 266 for automatically transmitting (e.g., e-mailing) a weekly Escalation Report to a specified distribution list; control then passes to a step 268. If, on the other hand, it is determined in the step 264 that no escalated findings exist, control passes directly to the step 268.

The weekly reporting process 56 ends in the step 264. As is evident from the above discussion, the system 20 mails out reports detailing activities, findings, observations and escalated findings for a specified period of time (e.g., a week). If any of the recordsets is empty (e.g., there are not any activities, observations, findings, or escalated findings for the week), the respective report is not sent. Furthermore, although the reporting process has been described in terms of a weekly reporting process, it is to be understood that other time frames (e.g., daily bi-weekly or monthly) are also contemplated.

Additionally, it is to be understood that the system 20 may generate management reports summarizing an SQA Engineer's performance and/or production. Also, the SQA Engineer may generate reports for tracking his/her schedule and/or production. Furthermore, a team may generate reports for evaluating trend analysis and/or performance. For example, a trend analysis report may indicate a team has produced an unusually high number of findings.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiment, the invention is now claimed to be:

1. A method for auditing an activity being implemented at an organization, the method comprising:
documenting, within a database included in a network accessible by the organization and an auditing entity, an activity to be audited;
auditing the activity;
determining if the audited activity produced a finding;
if the audited activity produced the finding, documenting the finding within the database; and
automatically transmitting, via the network, a notification of the finding from the auditing entity to the organization.

2. The method for auditing an activity as set forth in claim 1, further including:
determining if the audited activity produced an observation;
if the audited activity produced the observation, documenting the observation within the database; and
automatically transmitting, via the network, a notification of the observation from the auditing entity to the organization.

3. The method for auditing an activity as set forth in claim 1, further including:
resolving the finding.

4. The method for auditing an activity as set forth in claim 3, wherein the resolving step includes:
developing, within the organization, a proposed response for resolving the finding; and
transmitting, via the network, the proposed response to the auditing entity.

5. The method for auditing an activity as set forth in claim 4, wherein the resolving step further includes:
determining if the proposed response is acceptable to the auditing entity;
if the proposed response is acceptable, implementing the proposed response at the organization;
if the proposed response is not acceptable, performing a first negotiation between the organization and the auditing entity to determine a negotiated response;
if the negotiated response is acceptable to both the organization and the auditing entity, implementing the negotiated response at the organization; and
if the negotiated response is not acceptable to both the organization and the auditing entity, escalating a status of the finding.

6. The method for auditing an activity as set forth in claim 5, further including:
determining if the implemented response is acceptable to the auditing entity;
if the implemented response is acceptable to the auditing entity, setting a status of the finding to resolved;
if the implemented response is not acceptable to the auditing entity, performing second negotiations between the organization and the auditing entity; and
if the second negotiations do not result in a response acceptable to both the organization and the auditing entity, escalating a status of the finding.

7. The method for auditing an activity as set forth in claim 1, further including:
transmitting a report summarizing the finding, via the network, to a predefined addressee.

8. A system for auditing an activity implemented at an organization, comprising:
a network;
a client computing device communicating with the network;
a server computing device communicating with the network; and
a database communicating with the network, the activity to be audited being documented within the database, an auditing entity auditing the activity, if the audited activity produces a finding, the finding being documented within the database, and a notification of the finding being transmitted, via the network, from the auditing entity to the organization.

9. The system for auditing an activity implemented at an organization as set forth in claim 8, wherein if the audited activity produces an observation:
the observation being documented within the database; and
a notification of the observation being transmitted, via the network, from the auditing entity to the organization.

10. The system for auditing an activity implemented at an organization as set forth in claim 8, wherein a resolution to the finding is achieved via communications across the network between the auditing entity and the organization.

11. The system for auditing an activity implemented at an organization as set forth in claim 10, wherein the resolution is determined as a function of a proposed response, which is developed within the organization and transmitted to the auditing entity.

12. The system for auditing an activity implemented at an organization as set forth in claim 11, wherein:
if the proposed response is acceptable to the auditing entity, the organization implements the proposed response;
if the proposed response is not acceptable to the auditing entity, the organization and the auditing entity perform a first negotiation to determine a negotiated response;
if the negotiated response is acceptable to both the organization and the auditing entity, the organization implementing the negotiated response; and
if the negotiated response is not acceptable to both the organization and the auditing entity, a status of the finding being escalated.

13. The system for auditing an activity implemented at an organization as set forth in claim 12, wherein:
if the response implemented at the organization is acceptable to the auditing entity, the status of the finding being set to resolved;
if the response implemented at the organization is not acceptable to the auditing entity, a second negotiation being performed between the organization and the auditing entity; and
if the second negotiation does not result in a response acceptable to both the organization and the auditing entity, the status of the finding being escalated.

14. The system for auditing an activity implemented at an organization as set forth in claim 8, wherein:
a report summarizing the finding is transmitted, via the network, to a predefined addressee.

15. A method for automatically managing a quality assurance program, the method comprising:
identifying an activity to be audited;
auditing the activity; and
if the audited activity produces a finding, documenting the finding.

16. The method for automatically managing a quality assurance program as set forth in claim 15, further including:
if the audited activity produces an observation, documenting the observation.

17. The method for automatically managing a quality assurance program as set forth in claim 16, further including:
reporting the finding and the observation to a predetermined group.

18. The method for automatically managing a quality assurance program as set forth in claim 15,
negotiating a resolution to the finding between an auditor and a client.

19. The method for automatically managing a quality assurance program as set forth in claim 18, wherein the negotiating step includes:
sending a notification of the finding from the auditor to the client;
sending a desired response to the finding from the client to the auditor;
determining if the desired response is acceptable to the auditor;
if the response is acceptable to the auditor, implementing the desired response; and
if the response is not acceptable to the auditor, escalating a status of the finding.

20. The method for automatically managing a quality assurance program as set forth in claim 19, wherein:
the step of sending the notification includes:
e-mailing the notification from the auditor to the client; and
the step of sending the desired response includes:
e-mailing the desired response from the client to the auditor.

21. The method for automatically managing a quality assurance program as set forth in claim 19, further including:
if the implemented desired response is acceptable to the auditor, setting the finding status to resolved; and
if the implemented desired response is not acceptable to the auditor, negotiating a subsequent resolution to the finding between an auditor and a client.
